(19) United States
(12) Patent Application Publication
(10) Pub. No.: US 2015/0062881 A1
(43) Pub. Date: Mar. 5, 2015

(54) Enhanced Cake Topper

(71) Applicant: Michael Robert Mahoney, SR., Wentzville, MO (US)

(72) Inventor: Michael Robert Mahoney, SR., Wentzville, MO (US)

(21) Appl. No.: 14/011,405

(22) Filed: Aug. 27, 2013

(51) Int. Cl. F21V 33/00; F21V 23/00; F21V 15/01; A47G 19/30; F21S 9/02

(52) U.S. Cl. CPC F21V 33/0036; A47G 19/30; F21S 9/02; F21V 15/01; F21V 23/009; F21W 2121/00
USPC 362/183; 362/190

(57) ABSTRACT

One aspect of the invention uses a sealed housing and using a battery of sufficient voltage/power to continue the a light source projected for at least eight hours into the display. This light is directed onto a clear or translucent acrylic sheet or other material of similar properties using the described sheet as a light pipe. Any engraving in the surface of the material is highlighted and gives the appearance of a neon style light display. An illuminated display that is customizable, attractive, durable and easily cleaned. Accordingly, Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### FIELD OF THE INVENTION

The present invention relates to a device that is positioned in a cake or other confection. To provide a light source to project light into a material with lightpipe properties, to play music as desired, and to react to the end users actions and movements. More particularly, to aid in the adornment of a cake such that the cake's appearance will enhance special events or celebrations.

### BACKGROUND OF THE INVENTION

To present a cake or other confection in such a way as to enhance the appearance of the cake by personalizing it in an artful manner. To give the appearance and the sensation of a more elaborate or desirable cake or confection. This must be accomplished by providing a device that is low cost, low level of training, easily cleaned, and an appearance that can be customizable for the event.

Cakes and confections are made more personal by adding many different types of adornments. These can be tokens taken from an individuals life, a remnant of an event, a photograph, or an item that has a memory or can generate a memory. These adornments are placed or prepared on the cake or confection while trying to allow for an attractive appearance. These materials need to be edible or at least not toxic in nature.

U.S. Pat. No. 7,980,475, Jul. 19, 2011, Halbur; Ted C. (Lino Lakes, Minn.), Cake topper transaction product.

U.S. Pat. No. 8,223,196, Jul. 17, 2012, Carter; Charita Y. (Los Angeles, Calif.), Projector system and methods for producing digitally augmented, interactive cakes and other food products.

U.S. Pat. No. 4,416,075, Nov. 22, 1983, Bauer; Ronald (Overland, Mo.) Illuminated cake decoration.

Most decorations require a great amount of skill to produce a product with an attractive appearance. When using toys or other devices where they are not intended to be used on a cake or confection the cleaning and sanitation requirements may be difficult or impossible to achieve.

U.S. Pat. No. 7,980,475 Cake topper transaction product, hides a gift card in the cake to provide a surprise when cutting the cake but does not enhance the presentation of the cake. this device may be difficult to clean rendering it a single use product.

U.S. Pat. No. 8,223,196, Projector system and methods for producing digitally augmented interactive cakes and other food products' attempts to accomplish a similar enhancement, but, because it is projected flat on the top of the cake it can not be seen more then a few feet from the cake and does not work well on a tiered cake with a small surface area. The 3 dimensional version becomes even more complicated. This solution requires a team of highly qualified members to design the videos and project the finished product in concert with the cake or other food products.

U.S. Pat. No. 4,416,075, Illuminated cake decoration provides a low cost device, but, only lays flat and can not be easily customized for different events.

### SUMMARY OF THE INVENTION

In accordance with the present invention, there is provided an illuminating and electronically enhanced base that is easy to use, attractive, durable and easily cleaned to prevent contamination. This embodiment is a compact design that allows for the presenting of cakes and confections as shown with the advantages apparent from discussions herein. Displays of this type are common and have many applications. this invention is specific to cake decoration and the decoration of other confections where the electronics are not seen by the viewer, only the effects of the light on the display

Accordingly, one aspect of the invention uses a sealed housing and allows for the generation of light from Light Emitting Diodes (LED'S) or other light sources, and using a battery of sufficient voltage/power to continue the appropriate light source for at least eight hours. This light is directed onto a clear, tinted or translucent acrylic display or other material of similar properties and projected through the plastic sheet using the described sheet as a light pipe. Any engraving in the surface of the stated material is highlighted and gives the appearance of a neon style light display.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

It would be advantageous to provide a device that requires a lower level of skill to use while delivering a higher level of perceived quality by the user or end users.

It would also be advantageous to be able to position all parts except the display in the cake or other confection so as not to distract the viewer and allow the artist to decorate the area around the base of the illuminated display.

It would also be advantageous for the display to have light pipe abilities, could be see through, tinted, mirrored, decals, printed or many other visual effects, and easily replaceable for a variety of events at a low cost.

It would also be advantageous to provide a device that requires little maintenance between usage and can last up to 8 hours with appropriate light output, without requiring the power source to be replaced or recharged.

It would also be advantageous to provide a device that could act as a candle, when a person blows against the display one or more or the LED's could turn off. more time or more pressure will turn off more LED's.

It would further be advantageous to provide a device that is easy to clean and prepare for additional usage.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a rear view of an illuminated device completely assembled;

FIG. 2 is an exploded view of a complete assembly showing the electronic board containing battery, lights, and controls; and

FIG. 3 is a perspective view of an illuminated device showing typical, but not only, position in cake. the display and only a small portion of the upper housing is seen outside of the cake frosting.

For purposes of clarity and brevity, like elements and components will bear the same designations and numbering throughout the Figures.

### DESCRIPTION OF THE PREFERRED EMBODIMENT

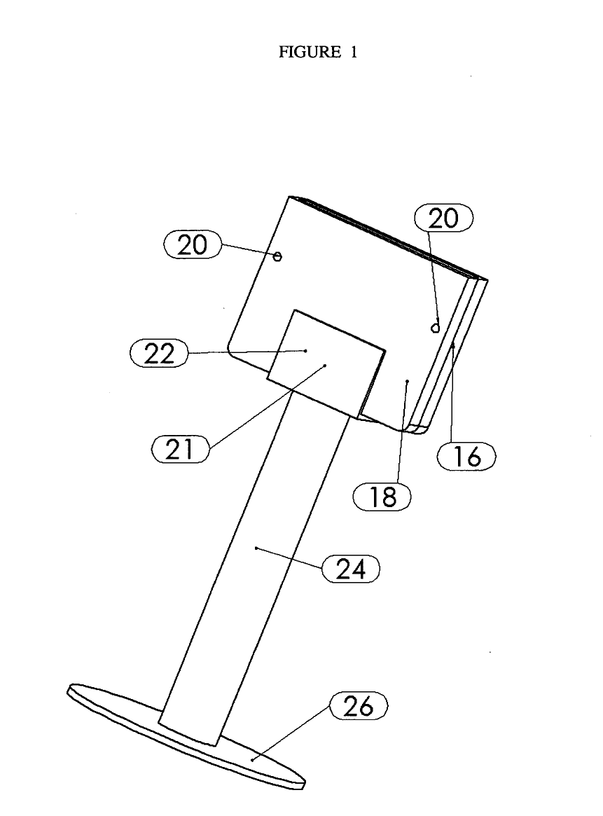

FIG. 1 is a front perspective view of an embodiment of the illuminated cake topper of the present invention.

The side one 16 provides the means by which the display 32 is held in concert with the light source positioned and contained by the side one 16 by using gravity or other forces such that the display 32 is standing vertical and perpendicular to the top of the cake or confection 34. Moreover, the side one 16 could be made of plastic, metal, casting resins, or any other suitable material known to those who are skilled in the art. Moreover the side one 16 communicates with the base support 26 through the standoff 24 to position the display 32 where the user or end user wishes it to be positioned.

The side two 18 when not positioned in concert and in alignment with the side one 16 provides access to the electronics, battery and other items located inside the side one 16. Moreover, the side two 18 could contain a battery door that when in place could maintain the sealed compartment, but, would allow for easier changing of the batteries. Moreover, when the side two 18 is positioned in concert and alignment with the side one 16 and locked in place using fasteners 20 or other techniques known to those skilled in the art, the electronics, battery and other items located inside the illuminated device are sealed and prevented from being damaged by the materials experienced in normal use and cleaning. This is only one embodiment and someone skilled in the art could provide for a design without the side two 18 or a different layout completely yet performing the same functions.

The housing clip 21 cradles the light body in the cake, allows the light body to be removable, as desired, and to assist in supporting the weight of the light body and display 32 while in the cake. The base support 26, standoff 24 and housing clip 21 work in concert to provide vertical and lateral support for the light body and display 32.

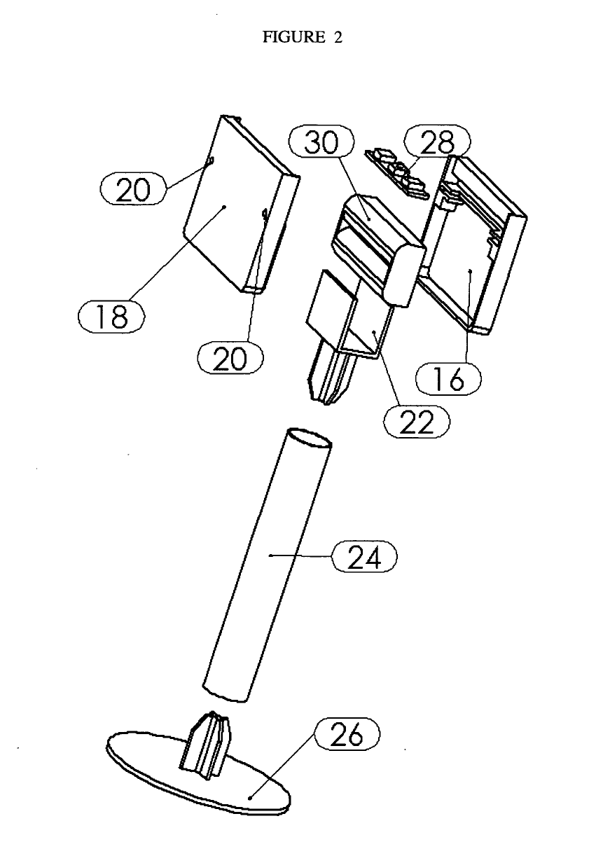

FIG. 2 is an exploded view of the main assembly. showing the position of the display 32 removed from the side one 16 and in alignment with the light source and the electronic board(s) 28. The preferred embodiment of the electronic board(s) 28 could be fabricated of any technique used to make electronic circuits including fiberglass, glass, fiber reinforced polymer resin or other materials known to those skilled in the art. The board or boards would have in communion with it, those components that provide the functions that are desired including, but, not limited to the battery, power regulation, recharging of the battery, blinking of the lights, color changing, music, speakers and any other artful or required functions. Moreover, the light sources are presented on the board such that the lights are projected into the edge of the display 32 allowing the light to pipe through the display 32. Moreover, the size of the electronic board(s) 28 should allow the electronic board(s) 28 that when placed into the side one 16 will be sealed and waterproof when used in such a manner that uses adhesives, potting compounds, silicones, casting resins, gaskets or other means known by those who are skilled in the art, to seal the electronics from the materials that could cause damage or contamination in normal usage but not alter the projection of light into the display 32.

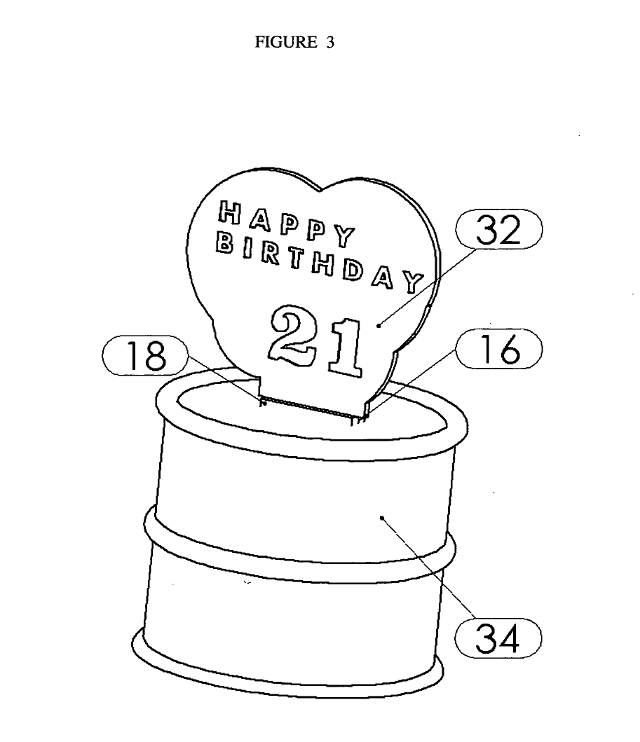

FIG. 3 is a front perspective view of a display 32. The display 32 could be fabricated of glass, crystal, acrylic, polycarbonate or any other suitable material. Moreover, the display 32 is shown as balloon in shape, but, could be round, square, cut to the shape of a person or many people, a tree line, a cityscape or any other shape found desirable by the user or end users. Moreover, the surfaces of the display 32 could be shinny. polished, bead blasted, frosted, painted, fixed with decals or decorated by those who are skilled in the art. Moreover, the thickness of the display 32 could be from 0.02 thick to over 0.25 inches thick but, could be less thick or more thick depending on the requirements of the end user, the intensity of the light source and the artistic requirements. Moreover, the material should be generally parallel minus the areas that are engraved with ether 2 dimensional or 3 dimensional adornments, however the artistic requirements could provide for surfaces that are not parallel. Moreover, the area displaying the illumination could be engraved, carved, injection molded, blow molded. or any other manufacturing technique used by those skilled in the art of manufacturing.

The display 32 could have engraved anything the user or end user can imagine to celebrate an event or special occasion. Standardized displays can be produced to provide a low cost solution for common events. A 21st birthday could be considered a common event. The complete illuminated device is shown in the cake or confection 34 in final assembly.

Thus, in summary, it can be seen that what is provided in this invention is an enhanced cake topper that is both functional and decorative. A display 32 appears above the cake or confection 34 surface, glowing in an artful embodiment, with it's shape and message determined by the users or end users. and can be purchased as a prepared ready to use sign, a partially prepared sign using some customization or a totally customized sign. Below the surface of the cake or confection 34 is the electronic board(s) 28 positioned in the boundaries of side one 16 suspended in a potting material, or by some other means, sealed from damage due to use and cleaning. Contained on the surface of the electronic board(s) 28 are the light sources to project light into the display 32, a battery or means to power the lights and other electronics, control circuits to provide for recharging, flashing, changing colors or any other artful projection of the user's imagination. And side one 16 that positions the display 32 vertical while positioning the light source to project into the edge of the display 32 providing the light pipe effect. A possible side two 18 that provides a sealed enclosure and possible access to the electronic board(s) 28. The standoff 24 (s) in concert with the base support 26 and the housing clip 21 provide the means in which the display 32 weight does not harm the cake or confection 34 and maintains a vertical attitude that is perpendicular to the cake or confection 34.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims:

1. An enhanced cake topper for promoting the enhancement of special events or celebrations, comprising:
means for positioning the light that is projected into the display, rigidly holding the display and easy cleaning;
means for keeping the unit clean and protecting the electronics, positioning the light source, could contain a battery door and holds the lights in communion with the edge of the display, rigidly attached to said means for positioning the light that is projected into the display, rigidly holding the display and easy cleaning;
means for source of light for the display, provide a means to power the light source, provides means to recharge battery, provide other effects such as lights flashing or changing colors, and provides sensors that could sense pressure or movement. and to conserve the battery when not in use, rigidly supported to said means for keeping the unit clean and protecting the electronics, positioning the light source, could contain a battery door and holds the lights in communion with the edge of the display, and rigidly supported to said means for positioning the light that is projected into the display, rigidly holding the display and easy cleaning;
means for temporarily securing the light body in the cake, allow the light body to be removable as desired and to assist in supporting the weight of the light body and display while in the cake. this part could be incorporated into the design of the light body or made a separate part, rigidly coupled to said means for keeping the unit clean and protecting the electronics, positioning the light source, could contain a battery door and holds the lights in communion with the edge of the display, and rigidly coupled to said means for positioning the light that is projected into the display, rigidly holding the display and easy cleaning;
means for providing a final enhanced appearance for the viewer, snugly inserted to said means for source of light for the display, provide a means to power the light source, provides means to recharge battery, provide other effects such as lights flashing or changing colors, and provides sensors that could sense pressure or movement. and to conserve the battery when not in use; and
means for providing power to the electronic functions associated with the electronic board.

2. The enhanced cake topper in accordance with claim 1, wherein said means for positioning the light that is projected into the display, rigidly holding the display and easy cleaning comprises a plate that retains the electronics' board or boards, holds display in a vertical position, contains all required electronics, provides means for holding stationary position in the cake or confection side one.

3. The enhanced cake topper in accordance with claim 1, wherein said means for keeping the unit clean and protecting the electronics, positioning the light source, could contain a battery door and holds the lights in communion with the edge of the display comprises a body that is sealed when attached to side 1, constrains the electronics' board or boards, holds display in a vertical position, positions light source in communion with the edge of the display, may contain a battery door for easy battery change side two.

4. The enhanced cake topper in accordance with claim 1, wherein said means for source of light for the display, provide a means to power the light source, provides means to recharge battery, provide other effects such as lights flashing or changing colors, and provides sensors that could sense pressure or movement. and to conserve the battery when not in use comprises a light emitting diode(s) to project light into the display, contains electronics necessary to provide desired functions such as blinking, color changing or recharging and power regulation, holds battery or other power source, provides means to seal the electronics from damage due to use or cleaning such as potting materials or gap filling adhesives but not limited to these, a switch can be mounted in the center of the lights to provide a means to conserve the battery when the display is not in use, could contain a sensor indicating pressure or movement electronic board(s).

5. The enhanced cake topper in accordance with claim 1, wherein said means for temporarily securing the light body in the cake, allow the light body to be removable as desired and to assist in supporting the weight of the light body and display while in the cake. this part could be incorporated into the design of the light body or made a separate part comprises a part that provides means to easily place the light unit securely in the cake, may contain a dimple or click fit with the light body, securely positions the light body with the standoff housing clip.

6. The enhanced cake topper in accordance with claim 1, wherein said means for providing a final enhanced appearance for the viewer comprises a transparent material with light pipe qualities, engraved to provide a means for light to reflect, display is held firm into the upper housing display.

7. The enhanced cake topper in accordance with claim 1, wherein said means for providing power to the electronic functions associated with the electronic board comprises an unit that provides power, could be rechargeable, could be replaceable battery pack.

8. An enhanced cake topper for promoting the enhancement of special events or celebrations, comprising:
a plate that retains the electronics' board or boards, holds display in a vertical position, contains all required electronics, provides means for holding stationary position in the cake or confection side one, for positioning the light that is projected into the display, rigidly holding the display and easy cleaning;
a body that is sealed when attached to side 1, constrains the electronics' board or boards, holds display in a vertical position, positions light source in communion with the edge of the display, may contain a battery door for easy battery change side two, for keeping the unit clean and protecting the electronics, positioning the light source, could contain a battery door and holds the lights in communion with the edge of the display, rigidly attached to said side one;
a light emitting diode(s) to project light into the display, contains electronics necessary to provide desired functions such as blinking, color changing or recharging and power regulation, holds battery or other power source, provides means to seal the electronics from damage due to use or cleaning such as potting materials or gap filling adhesives but not limited to these, a switch can be mounted in the center of the lights to provide a means to conserve the battery when the display is not in use, could contain a sensor indicating pressure or movement electronic board(s), for source of light for the display, provide a means to power the light source, provides means to recharge battery, provide other effects such as lights flashing or changing colors, and provides sensors that could sense pressure or movement. and to conserve the battery when not in use, rigidly supported to said side two, and rigidly supported to said side one;
a part that provides means to easily place the light unit securely in the cake, may contain a dimple or click fit with the light body, securely positions the light body with the standoff housing clip, for temporarily securing the light body in the cake, allow the light body to be removable as desired and to assist in supporting the weight of the light body and display while in the cake. this part could be incorporated into the design of the light body or made a separate part, rigidly coupled to said side two, and rigidly coupled to said side one;
a transparent material with light pipe qualities, engraved to provide a means for light to reflect, display is held firm into the upper housing display, for providing a final enhanced appearance for the viewer, snugly inserted to said electronic board(s); and
an unit that provides power, could be rechargeable, could be replaceable battery pack, for providing power to the electronic functions associated with the electronic board.

9. The enhanced cake topper as recited in claim 8, further comprising:
a part that holds upper housing in position while in use in the cake or confection, holds upper housing in communion with the base support standoff, for providing a proper height for the assembly in the cake and to assist in preventing damage to the surrounding area of the cake caused by the weight of the light body and display as well as by not allowing side movement, intimately adhered to said housing clip.

10. The enhanced cake topper as recited in claim 8, further comprising:
a part that supports the weight of upper housing assembly, protects the cake or other confection from damage while the cake or other confection is being displayed prior to serving, is not obvious to the viewer while in use base support, for support the weight and stabilizes the assembly by preventing side to side movement while in the cake, intimately coupled to said standoff.

11. The enhanced cake topper as recited in claim 8, further comprising:
an object used to hold the unit together, permanent or reuseable, could be a molded click fit or separate fasteners, for object that hold side one and side two together and assists in keeping the unit sealed and easy to clean as well as containing the body to allow the light source and the edge of the display to remain in communion.

12. The enhanced cake topper as recited in claim 9, further comprising:
a part that supports the weight of upper housing assembly, protects the cake or other confection from damage while the cake or other confection is being displayed prior to serving, is not obvious to the viewer while in use base support, for support the weight and stabilizes the assembly by preventing side to side movement while in the cake, intimately coupled to said standoff.

13. The enhanced cake topper as recited in claim 9, further comprising:
an object used to hold the unit together, permanent or reuseable, could be a molded click fit or separate fasteners, for object that hold side one and side two together and assists in keeping the unit sealed and easy to clean as well as containing the body to allow the light source and the edge of the display to remain in communion.

14. The enhanced cake topper as recited in claim 10, further comprising:
an object used to hold the unit together, permanent or reuseable, could be a molded click fit or separate fasteners, for object that hold side one and side two together and assists in keeping the unit sealed and easy to clean as well as containing the body to allow the light source and the edge of the display to remain in communion.

15. The enhanced cake topper as recited in claim 12, further comprising:
an object used to hold the unit together, permanent or reuseable, could be a molded click fit or separate fasteners, for object that hold side one and side two together and assists in keeping the unit sealed and easy to clean as well as containing the body to allow the light source and the edge of the display to remain in communion.

16. An enhanced cake topper for promoting the enhancement of special events or celebrations, comprising:
a plate that retains the electronics' board or boards, holds display in a vertical position, contains all required electronics, provides means for holding stationary position in the cake or confection side one, for positioning the light that is projected into the display, rigidly holding the display and easy cleaning;
a body that is sealed when attached to side 1, constrains the electronics' board or boards, holds display in a vertical position, positions light source in communion with the edge of the display, may contain a battery door for easy battery change side two, for keeping the unit clean and protecting the electronics, positioning the light source, could contain a battery door and holds the lights in communion with the edge of the display, rigidly attached to said side one;
a light emitting diode(s) to project light into the display, contains electronics necessary to provide desired functions such as blinking, color changing or recharging and power regulation, holds battery or other power source, provides means to seal the electronics from damage due to use or cleaning such as potting materials or gap filling adhesives but not limited to these, a switch can be mounted in the center of the lights to provide a means to conserve the battery when the display is not in use, could contain a sensor indicating pressure or movement electronic board(s), for source of light for the display, provide a means to power the light source, provides means to recharge battery, provide other effects such as lights flashing or changing colors, and provides sensors that could sense pressure or movement. and to conserve the battery when not in use, rigidly supported to said side two, and rigidly supported to said side one;
a part that provides means to easily place the light unit securely in the cake, may contain a dimple or click fit with the light body, securely positions the light body with the standoff housing clip, for temporarily securing the light body in the cake, allow the light body to be removable as desired and to assist in supporting the weight of the light body and display while in the cake. this part could be incorporated into the design of the light body or made a separate part, rigidly coupled to said side two, and rigidly coupled to said side one;
a transparent material with light pipe qualities, engraved to provide a means for light to reflect, display is held firm into the upper housing display, for providing a final enhanced appearance for the viewer, snugly inserted to said electronic board(s);
a part that holds upper housing in position while in use in the cake or confection, holds upper housing in communion with the base support standoff, for providing a proper height for the assembly in the cake and to assist in preventing damage to the surrounding area of the cake caused by the weight of the light body and display as well as by not allowing side movement, intimately adhered to said housing clip;
a part that supports the weight of upper housing assembly, protects the cake or other confection from damage while the cake or other confection is being displayed prior to serving, is not obvious to the viewer while in use base support, for support the weight and stabilizes the assembly by preventing side to side movement while in the cake, intimately coupled to said standoff;
an unit that provides power, could be rechargeable, could be replaceable battery pack, for providing power to the electronic functions associated with the electronic board; and
an object used to hold the unit together, permanent or reuseable, could be a molded click fit or separate fasteners, for object that hold side one and side two together and assists in keeping the unit sealed and easy to clean as well as containing the body to allow the light source and the edge of the display to remain in communion.
